(19) United States
(12) Patent Application Publication
(10) Pub. No.: US 2026/0356987 A1
(43) Pub. Date: Nov. 12, 2026

(54) SYNTHESIS OF CARBOXYMETHYL CELLULOSE WITH LOW GEL PARTICLES

(71) Applicant: NUTRITION & BIOSCIENCES USA 1, LLC, Rochester, NY (US)

(72) Inventor: Oliver Petermann, Bomlitz (DE)

(21) Appl. No.: 19/140,039

(22) PCT Filed: Jan. 16, 2024
(86) PCT No.: PCT/US2024/011600

§ 371 Date: Jun. 17, 2025

(30) Foreign Application Priority Data
Jan. 16, 2023 (EP) 23151800.2

(51) Int. Cl. C08B 11/12; H01M 4/62; H01M 10/0525

(52) U.S. Cl. CPC C08B 11/12; H01M 4/622; H01M 10/0525

(57) ABSTRACT

The present invention is directed to a carboxymethyl cellulose (CMC) with low gel particles, compositions comprising CMC, their methods of preparation and uses thereof.

### FIELD OF THE INVENTION

The present invention is directed to a carboxymethyl cellulose (CMC), particularly carboxymethyl cellulose (CMC) with low gel particles, compositions comprising CMC, their methods of preparation and uses thereof in for example batteries.

### BACKGROUND

CMCs are used in a wide variety of technical fields. Areas which benefit from the thickening and gel-forming properties of CMC are, for example, oil industry (e.g., in drilling fluids), food industry, pharmaceutical industry, paper industry, electrical and electronic industry, textile industry and construction industry.

The significant growth of electrical vehicles and portable electronic devices has led to an increase in the demand for rechargeable batteries, especially the various types of lithium-ion batteries (LIB), in which CMC acts as a binder for the graphite anode. However, undissolved CMC particles, such as gel particles in aqueous CMC solutions, tend to decrease the battery performance in LIB as they result in defects in the anode of the battery.

One way to reduce undissolved CMC particles is to filtrate the CMC solution as described in EP2355215B1.

Another way to produce CMC with reduced gel particles is described in EP3187509B1, in which a process comprising a step in which a base is added to adjust the pH of the reaction mixture to 8.0 to 9.0 and a step in which a heat treatment is performed at 40 °C to 70 °C for 30 minutes to 120 minutes.

However, there is still the need to prepare CMC with low undissolved CMC particles, such as low gel particles.

### OBJECT OF INVENTION

In order to overcome the current challenges of providing CMC with low undissolved particles, such as low gel particles, the inventors have now shown that using a process in which the ratio alkalizing agent/monohaloacetic acid is above 2 and wherein a step of adding a base to adjust the pH of the reaction mixture and a step of heat treating the reaction mixture are avoided, this provides a CMC with low gel particles.

It is therefore an object of the present invention to provide a new process for preparing types of CMC with low gel particles.

### SUMMARY OF THE INVENTION

The problem is solved by a process of preparing carboxymethyl cellulose (CMC) comprising the steps of:
a) suspending non-regenerated cellulose in a mixture of water/alcohol solvent, adding an alkalizing agent, and reacting the non-regenerated cellulose with the alkalizing agent in the presence of the water/alcohol solvent, optionally adding hydrogen peroxide,
b) then adding a monohaloacetic acid or a salt thereof to the alkalized cellulose of step a), and reacting the alkalized cellulose of step a) with the monohaloacetic acid or the salt thereof,
c) adding an acid to the reaction mixture of step b) to adjust the pH of the reaction mixture to 6.0 to 8.0, and
d) removing the solvent after step c) is complete,
wherein the ratio alkalizing agent/monohaloacetic acid is above 2 and wherein the process after step d) is complete does not contain a further step of adding a base to adjust the pH of the reaction mixture and a further step of heat treating the reaction mixture.

The present invention is also directed to the novel CMCs obtained and obtainable by the process as described herein.

The present invention further concerns carboxymethyl cellulose (CMC) having a degree of substitution (DS) equal to or below 0.5 and having a number of gel particles below 200/5 cm×5 cm, more preferably equal to or below 100/5 cm×5 cm, more preferably equal to or below 50/5 cm×5 cm, even more preferably equal to or below 25/5 cm×5 cm, most preferably equal to or below 15/5 cm×5 cm, when measured as 1% solution in water.

Another aspect of the present invention concerns compositions comprising carboxymethyl cellulose obtained or obtainable by the process as described herein, or comprising carboxymethyl cellulose as described herein, wherein the number of gel particles is equal to or below 200/5 cm×5 cm, more preferably equal to or below 100/5 cm×5 cm, more preferably equal to or below 50/5 cm×5 cm, even more preferably equal to or below 25/5 cm×5 cm, most preferably equal to or below 15/5 cm×5 cm.

A further aspect of the present invention is the use of the compositions as described herein as a coating agent for battery electrodes.

Another aspect of the present invention is the use of carboxymethyl cellulose as a thickening agent and/or gelling agent, binder, stabilizer, emulsifier, film forming agent, suspending agent, protective colloid, crystallization inhibitor, or as enteric coatings.

A further aspect of the present invention is the use of carboxymethyl cellulose in drilling fluids, such as oil drilling fluids; in pharmaceutical dosage forms, such as capsules, tablets, solutions, suspensions, emulsions, creams, and lotions; in food products, such as processed meat products, dairy products, bakery products, structured, extruded or coated food products, like meat substitutes, dressings, sauces, marinades, soups and spreads; in cosmetic applications, such as hair styling products, toothpastes, emulsions, creams and lotions; in detergents; in paper coating or paper binding; in welding electrodes; in textile applications, such as textile printing and dyeing; in house care applications like laundry and dish washing; in ceramic applications, such as clay bodies and tile production; in adhesives; in paints; and in construction applications, such as gypsum or cement based dry mortar applications; as a polymer component in crosslinked interfacially formed capsules.

### DETAILED DESCRIPTION OF INVENTION

The detailed aspects of this invention are set out below. Some of the detailed aspects are discussed in separate sections. This is for ease of reference and is in no way limiting. All the embodiments described below are equally applicable to all aspects of the present invention unless the context specifically dictates otherwise.

The term “CMC” or “carboxymethyl cellulose” as used herein encompasses carboxymethyl cellulose or salts thereof, such as cellulose substituted with groups of the formula —CH₂CO₂A, wherein A is hydrogen or a monovalent cation, such as K⁺ or preferably Na⁺. Examples of the salt of carboxymethyl cellulose may include metal salts such as sodium carboxymethyl cellulose salt.

The process of preparing carboxymethyl cellulose according to the present invention comprises the steps of:
a) suspending non-regenerated cellulose in a mixture of water/alcohol solvent, adding an alkalizing agent, and reacting the non-regenerated cellulose with the alkalizing agent in the presence of the water/alcohol solvent, optionally adding hydrogen peroxide,
b) then adding a monohaloacetic acid or a salt thereof to the alkalized cellulose of step a), and reacting the alkalized cellulose of step a) with the monohaloacetic acid or the salt thereof,
c) adding an acid to the reaction mixture of step b) to adjust the pH of the reaction mixture to 6.0 to 8.0, and
d) removing the solvent after step c) is complete,
wherein the ratio alkalizing agent/monohaloacetic acid is above 2 and wherein the process after step d) is complete does not contain a further step of adding a base to adjust the pH of the reaction mixture and a further step of heat treating the reaction mixture.

As used herein, the term “regenerated cellulose” refers to cellulose that has been prepared by regeneration (i.e., return to solid form) from a solution that includes dissolved cellulose fibers. The term “non-regenerated cellulose” refers to cellulose that has not gone through a process of dissolving cellulose, typically cellulose fibers, in a solvent, and then regenerating it from that solution, i.e., recovering cellulose in solid form. In particular “non-regenerated cellulose” refers to cellulose that has not been recovered from a cellulose xanthogenate solution or a cellulose/cuprammonium solution or a solution of cellulose in N-methylmorpholin-N-oxide.

Non-regenerated cellulose to be used for preparing the CMC are natural cellulose, such as cotton linters and wood pulp, e.g. hard wood or soft wood pulp. Typically, cotton linters or wood pulp are used, depending on the desired application of the CMC. Pulps according to present invention have a limiting viscosity number measured according to ISO 5351:2010 from 50 to 300 mL/g, preferably from 1000 to 3000 mL/g and more preferably from 300 to 1000 mL/g.

The essential steps of the preparation method of carboxymethyl cellulose are alkalizing the cellulose by reaction with the alkalizing agent (alkalizing step (a)) and adding monohaloacetic acid to cause etherification of the alkali cellulose (carboxymethylation step (b)).

The cellulose is first alkalized in the presence of water and alcohol (isopropyl alcohol and or methanol) in the alkalizing step (a) and then the monohaloacetic acid is added in the carboxymethylation step. In the alkalizing step, the single components (e.g. cellulose, water, alcohol, alkalizing agent) can be added in arbitrary order. However, it is preferred that the cellulose is combined with water, isopropyl alcohol, and optionally methanol in a first step and the alkalizing agent is then added in a subsequent step.

There are various options how to contact the cellulose with the alkalizing agent. Preferably, cellulose powder is used as starting material. Typically, the cellulose powder is suspended (slurried) in the solvent/water mixture comprising water, alcohol (isopropyl alcohol and or methanol) before the alkalizing agent is added as a solid or as an aqueous solution.

According to the preferred slurry method, the alkalizing step (a) is typically conducted at a temperature within the range of from 10 to 40 °C, preferably from 15 to 40 °C, more preferably from 15 to 30 °C, even more preferably from 18 to 25 °C, and most preferably at about 20 °C. Typical reaction times for the alkalization step range from 15 to 120 min, preferably from 40 to 100 min, and more preferably from 50 to 80 min depending on the reaction temperature. In one embodiment the alkalizing step is conducted at about 20 °C for 50 to 70 min, preferably for 60 min.

In the carboxymethylation step (b) the monohaloacetic acid or a salt thereof, preferably the sodium salt, can be added neat or as a solution, preferably as an aqueous solution or as a solution in water and isopropyl alcohol and optionally methanol. The carboxymethylation step is typically conducted at a temperature within the range of from 40 to 100 °C, preferably from 50 to 90 °C, more preferably from 60 to 80 °C, and most preferably at about 70 °C. In preferred embodiments the monohaloacetic acid is already added to the reaction mixture before the carboxymethylation temperature is reached; more preferably the monohaloacetic acid is already added before the heating-up phase begins or within the first minutes of the heating-up phase, generally at a temperature which is described above for the alkalizing step, e.g. at from 15 to 40 °C. The early addition of the monohaloacetic acid at lower temperatures may avoid an undesired degradation of the cellulose (resulting in a decrease of viscosity) which may occur at the higher temperatures in absence of monohaloacetic acid. After the desired temperature of the carboxymethylation step (carboxymethylation temperature) as mentioned before is reached, the carboxymethylation temperature is typically held for a period of from 0 to 180 min, preferably from 20 to 140 min.

The product obtained from the carboxymethylation step, i.e. the etherification, is the sodium or potassium salt of carboxymethyl cellulose depending on which alkalizing agent was employed. According to a preferred embodiment the CMC salt is neutralized by adding acid, preferably an organic acid such as acetic acid or formic acid, more preferably acetic acid. Herein “neutralizing” means adjusting the pH value to a value of from 6 to 9, preferably 6 to 8.

The CMC is then separated from the reaction mixture and purified, if necessary, depending on the intended end-use, and dried. Purification is performed according to standard methods well-known to the person skilled in the art. For example, the CMC can be washed with organic solvents including mixtures of organic solvents and solvent(s)/water mixtures, such as methanol, acetone, methanol/water mixtures, acetone/methanol mixtures, and methanol/isopropyl alcohol/water mixtures.

The alkalizing agent is preferably NaOH, KOH or a mixture thereof. In one embodiment of the invention NaOH is used as the alkalization agent. In another embodiment KOH is used as the alkalization agent. In the latter case remaining K⁺ ions in the produced CMC are preferably exchanged by Na⁺ ions in a subsequent step.

The monohaloacetic acid can be used as free acid or in its salt form. Preferably, monochloroacetic acid or its salt is used in the inventive process, including all preferred embodiments described in the following.

According to the present invention, it is important to observe the molar ratios of each of the above-described components during preparation of the CMC.

The ratio alkalizing agent/monohaloacetic acid is between 2.1-20, preferably between 2.5-20; more preferably between 4.0-20.

In other aspects, the ratio alkalizing agent/monohaloacetic acid is between 2.6-20, between 2.8-20, between 3.0-20 or between 3.5-20.

In another aspect, the ratio alkalizing agent/monohaloacetic acid is between 2.1-15, preferably between 2.5-15; more preferably between 4.0-15.

In other aspects, the ratio alkalizing agent/monohaloacetic acid is between 2.6-15, between 2.8-15, between 3.0-15 or between 3.5-15.

In a further aspect, the ratio alkalizing agent/monohaloacetic acid is between 2.1-10, preferably between 2.5-10; more preferably between 4.0-10.

In other aspects, the ratio alkalizing agent/monohaloacetic acid is between 2.6-10, between 2.8-10, between 3.0-10 or between 3.5-10.

In a particular aspect, the alkalizing agent is added as a solid.

“Solvent” and like terms mean a substance that is capable of dissolving another substance (i.e., a solute) to form an essentially uniformly dispersed mixture (i.e., solution) at the molecular or ionic size level.

In a preferred embodiment of the invention non-regenerated cellulose is reacted with the alkalization agent in the presence of water/alcohol solvent.

In a particular aspect of the present invention, the alcohol is isopropyl alcohol and or methanol.

In further particular aspect, 10 to 100 mol of alcohol are used in the process as described herein based on 1 mol of anhydroglucose unit of the cellulose.

In a further aspect, the present invention also concerns a carboxymethyl cellulose obtained or obtainable by the process as described herein.

When an aqueous solution of CMC is prepared, gel particles derived from the CMC may remain as an unsolved substance in the aqueous solution. A mechanical dry or wet pulverization process for the CMC can reduce the size of the gel particles in the aqueous solution, however, the result may still be separation of a coating or pinholes on the electrode.

It has surprisingly been found that the compositions as disclosed herein have a very low amount of gel particles, such as a number of gel particles below 200/5 cm×5 cm, more preferably equal to or below 100/5 cm×5 cm, more preferably equal to or below 50/5 cm×5 cm, more preferably equal to or below 25/5 cm×5 cm, most preferably 15/5 cm×5 cm.

The carboxymethyl cellulose (CMC) disclosed herein has a degree of substitution (DS) equal to or below 0.5 and has a number of gel particles below 200/5 cm×5 cm, more preferably equal to or below 100/5 cm×5 cm, more preferably equal to or below 50/5 cm×5 cm, more preferably equal to or below 25/5 cm×5 cm, more preferably equal to or below 15/5 cm×5 cm

In a particular aspect, the carboxymethyl cellulose (CMC) has a degree of substitution (DS) below 0.4

The degree of substitution (DS) is the average number of OH groups that have been substituted in one anhydroglucose unit. It is determined according to ASTM D 1439-03 “Standard Test Methods for Sodium Carboxymethylcellulose; Degree of Etherification, Test Method B: Nonaqueous Titration”. The treatment of a solid sample of the CMC with glacial acetic acid at boiling temperature releases an acetate ion quantity equivalent to the sodium carboxymethyl groups. These acetate ions can be titrated as a strong base in anhydrous acetic acid using a perchloric acid standard solution. The titration end point is determined potentiometrically. Other alkaline salts of carboxylic acids (e. g. sodium glycolate and di-sodium diglycolate) behave similarly and are co-titrated.

The present invention also concerns compositions comprising carboxymethyl cellulose as described herein.

The compositions comprising the CMC's disclosed herein have a number of gel particles equal to or below 200/5 cm×5 cm, more preferably equal to or below 100/5 cm×5 cm, more preferably equal to or below 50/5 cm×5 cm, more preferably equal to or below 25/5 cm×5 cm, most preferably equal to or below 15/5 cm×5 cm.

In one aspect of the present invention the novel CMCs typically have a viscosity, measured as a 1 weight % aqueous solution as described below, of at least 100 mPa·s, preferably at least 200 mPa·s, more preferably at least 600 mPa·s, and most preferably of at least 100 mPa·s. The viscosity is generally up to 40,000 mPa·s, preferably up to 30,000 mPa·s, preferably up to 25,000 mPa·s, more preferably up to 20,000 mPa·s, measured as a 1 weight % aqueous solution as described below.

In order to determine the viscosity, a 1% solution is prepared as follows (total amount of solution 300 g). 294 g deionized water (water in CMC is subtracted) is placed in 500 ml screw cap bottle which is being thermostated at 25 °C. 6 g (dry weight) of the CMC is then stirred in evenly at a rotating speed of approx. 1300 to prepare a solution. After that the solution is stirred at a constant rotating speed (approx. 1000-1500 rpm) and at a temperature of 25 °C for 1 h and 30 min. Then the stirrer is switched off, the solution is kept at 25 °C without stirring for 30 minutes before the viscosity is determined. The viscosity of the solution was measured using a Brookfield LVT viscometer, 30 rpm, 25° with spindle 3 for examples 1-3 and example 7 and spindle 2 for examples 4-6 and example 8-11

1 weight % aqueous solutions of CMC are prepared as described above in connection with the viscosity analysis with additional rolling on a roller device for 24 h. The transmission and the turbidity are analyzed with the Turbidimeter 2100AN using a tungsten filament lamp emitting light of a wavelength of 300 to 1000 nm (Hach Company, Loveland, Colorado, USA). The transmission is the photometric analysis of the transmitted light through a sample cell (diameter: 24 mm) at a given wavelength (here 610 nm). It is given in % transmitted light. The system is calibrated against water (100% transmission). The result is the average of eight measurements. The turbidity is the analysis of the scattered light through a sample cell (diameter: 24 mm) and is given in NTUs (nephelometric turbidity units) according to USEPA method 180.1. The analysis is performed against a formazan standard ranging from <0.1 NTU to 7500 NTU (StablCal™, catalogue number 2659505). A USEPA method 180.1 filter module (catalogue number 3031200, 400 to 600 nm) is used. The result is the average of ten measurements.

Disclosed herein is further a battery electrode, wherein the electrode is coated with a composition as disclosed herein. Disclosed herein is further a lithium-ion battery electrode, such as a secondary battery electrode coated with a composition as disclosed herein. In an embodiment, the electrode is an anode. In a further embodiment, the electrode is a cathode. Disclosed herein is also a battery comprising a battery electrode as disclosed herein.

“Active material” and like terms mean, as used in the context of a lithium-ion battery, a substance that is either the source of lithium ions or that can receive and accept lithium ions. In the context of the cathode of a lithium-ion cell, the active material is the source of the lithium ions, e.g., lithium cobalt oxide, lithium manganese oxide, etc. In the context of the anode of a lithium-ion cell, the active material is the receptor of the lithium-ions, e.g., graphite. The active materials are typically in the form of very small particles having a diameter from 100 nanometres to 100 micrometres.

“Anode” and like terms, as used in the context of a lithium-ion battery, mean the negative electrode in the discharge cycle. The anode is the electrode where oxidation takes place within the battery during discharge, i.e., electrons are freed and flow out of the battery.

“Battery” and like terms mean a collection of cells or cell assemblies which are ready for use. A battery typically contains an appropriate housing, electrical interconnections, and, possibly, electronics to control and protect the cells from failure, e.g., fire, thermal runaway, explosion, loss of charge, etc. The simplest battery is a single cell. Batteries can be primary, i.e., non-rechargeable, and secondary, i.e., rechargeable.

“Binder polymers” and like terms mean, as used in the context of a lithium-ion battery, a polymer that holds the active material particles within an electrode of a lithium-ion battery together to maintain a strong connection between the electrode and the contacts. Binder polymers are normally inert to the substances in which they are in contact within the lithium-ion battery during discharging, charging and storage.

“Cathode” and like terms, as used in the context of a lithium-ion battery, mean the positive electrode in the discharge cycle. The lithium in a lithium-ion battery is in the cathode. The cathode is the electrode where reduction takes place within the battery during discharge.

“Cell” and like terms mean a basic electrochemical unit that contains the electrodes, separator, and electrolyte.

“Conductive agent” and like terms mean, as used in the context of a lithium-ion battery, a substance that promotes the flow of ions between the electrodes of a cell. Carbon-based compounds and materials, e.g., acetylene black, carbon nanotubes, carbon-based polymers, and the like, are typical conductive agents used in lithium-ion batteries.

“Electrolyte” and like terms mean, as used in the context of a lithium-ion battery, a substance that carries positively charged lithium ions from the anode to the cathode, and vice versa, through a separator.

“Lithium-ion battery” and like terms mean a rechargeable (i.e., a secondary) battery in which lithium ions move from the negative electrode to the positive electrode during discharge and back when charging. Lithium-ion batteries use an intercalated lithium compound as one electrode material as opposed to the metallic lithium used in a non-rechargeable lithium battery (also known as a primary battery). The electrolyte, which allows for ionic movement, and the two electrodes are the constituent components of a lithium-ion battery cell.

“Separator” and like terms mean, as used in the context of a lithium-ion battery, a thin, porous membrane that physically separates the anode and cathode. The primary function of the separator is to prevent physical contact between the anode and cathode, while facilitating lithium-ion transport within the cell. Separators are typically a simple plastic film, e.g., polyethylene or polypropylene, or a ceramic, with a pore size designed to allow lithium-ion transit.

The CMC's according to the present invention have been shown to be very useful as a coating agent for battery electrodes, such as lithium ion battery electrodes, preferably secondary battery electrodes. In one aspect, the battery electrode is a cathode or an anode.

In one aspect, the present invention also concerns batteries wherein the electrodes are coated with compositions as described herein. In particular, the electrodes are lithium-ion electrodes. In a particular case, the batterie electrode is a secondary batterie electrode. The electrode can be an anode or a cathode.

Another aspect of the present invention is the use of carboxymethyl cellulose as a thickening agent and/or gelling agent, binder, stabilizer, emulsifier, film forming agent, suspending agent, protective colloid, crystallization inhibitor, or as enteric coatings.

A further aspect of the present invention is the use of carboxymethyl cellulose in drilling fluids, such as oil drilling fluids; in pharmaceutical dosage forms, such as capsules, tablets, solutions, suspensions, emulsions, creams, and lotions; in food products, such as processed meat products, dairy products, bakery products, structured, extruded or coated food products, like meat substitutes, dressings, sauces, marinades, soups and spreads; in cosmetic applications, such as hair styling products, toothpastes, emulsions, creams and lotions; in detergents; in paper coating or paper binding; in welding electrodes; in textile applications, such as textile printing and dyeing; in house care applications like laundry and dish washing; in ceramic applications, such as clay bodies and tile production; in adhesives; in paints; and in construction applications, such as gypsum or cement based dry mortar applications; as a polymer component in crosslinked interfacially formed capsules.

### EXAMPLES

The following examples are provided for illustrative purposes only and are not intended to limit the scope of the claims that follow. Unless otherwise indicated, all parts and percentages are by weight.

First, cellulose powder was introduced into a dry 3 litre laboratory reactor and then, the solvent mixture of isopropyl alcohol, methanol and water was added under ambient atmosphere or nitrogen atmosphere. NaOH (as prills) were added under stirring at a temperature of 20 °C, stirring was continued for 15 minutes after which hydrogen peroxide was added in a concentration of 3% in water (examples 7-11); stirring continued at 20 °C for a total of 60 min. Afterwards, the reaction mixture was heated up to 70 °C within 40 min and the monochloroacetic acid was added as a 79.6 weight % aqueous solution during the first minutes of the heating-up phase. The temperature of 70 °C was held for 120 min during the carboxymethylation step and then the reaction mixture was cooled down to 20 °C within about 60 min. The pH value of the cooled reaction mixture was adjusted to 7.5 with acetic acid and the solution was subsequently filtered. The filter residue was subsequently washed at least 5 times with 2 l of an isopropanol/methanol/water mixture (isopropanol/methanol/water weight ratio of 5:3:2) until no chloride ions were detected in the filtrate. This was followed by one final washing step with pure methanol. The washed samples were dried overnight in the drying cabinet at 55 °C and then milled in a laboratory mill.

The degree of substitution of the CMCs obtained was determined as described in the general part of the specification. 1 weight % solutions of the CMC samples were also prepared, and their viscosity, turbidity and transmission were determined as described in the general part of the specification.

### Determination of the Number of Gel Particles

In order to determine the number of gel particles as described herein, gels are observed via a wet coating method by coating CMC solution on surface treated PET film and then do the counting in a 5 cm×5 cm square area with repeat tests. The CMC solutions were made under the following detailed process: Around 1.000 grams CMC powders were dispersed on the surface of aluminium foil in the automatic moisture testing machine (moisture analyzer MA37 from Sartorius AG, Germany). The moisture testing is run using the automatic testing process at a temperature of 130 °C. The CMC solution is prepared by adding 135.5 grams of deionized water into the metal cup of a high-speed mixer and mix at a speed at 300 rpm. Add around 1.5 grams CMC powders to the water. After all the powders are dispersed in the water, increase the mixing speed to 4000 rpm and keep the mixing for 30 minutes. A clear aqueous solution is obtained with many bubbles inside due to the high-speed mixing. The prepared CMC solution should be stored at room temperature for one day to remove the bubbles off the solution. Then A4 size papers are prepared with 5 cm×5 cm squares and covered by the same size PET film. Several drops of prepared CMC solution are sucked from the middle/bottom area of CMC solution bottle and then released on the left side of the PET film in close square areas, and followed by casting from left side to the right side using knife blade with 100 micro meter gap. The wet coating of CMC solution on PET film was observed under LED light, and the bright spots were identified as insoluble gels. The gel number was calculated from each square and recorded by two persons to reduce the manual observation error. One trick to help the observation clearly is to add one piece of glass between the A4 paper background and PET film which will make it very clear showing with bright spots for the gels.

TABLE 1

| | Examples | | | |
|---|---|---|---|---|
| | Comparative | | | |
| Material and | example | Example | Example | Example |
| reaction conditions | (681) | 1 (683) | 2 (684) | 3 (685) |
| Pulp | 50% Borregaard Blue Bear VHV + 50% | | | |
| | Tartas Biofloc HVBR | | | |
| mol pulp | 0.4 + 0.4 | | | |
| Ratio NaOH/Acid | 2 | 2.17 | 2.28 | 2.37 |
| Sodium Hydroxide | 1.8 | 2.0 | 2.1 | 2.2 |
| (mol/mol AGU) | | | | |
| Sodium Hydroxide (g) | 57.6 | 64 | 67.19 | 70.39 |
| Chloroacetic acid | 0.9 | 0.92 | 0.92 | 0.93 |
| (mol/mol AGU) | | | | |
| Chloroacetic acid | 85.37 | 87.27 | 87.27 | 88.22 |
| (79.7 wt-% in | | | | |
| water) (g) | | | | |
| Isopropanol (g) | 1793.3 | 1793.3 | 1793.3 | 1793.3 |
| Methanol (g) | 104.45 | 104.45 | 104.45 | 104.45 |
| Water (g) | 216.61 | 216.61 | 216.61 | 216.61 |
| Results | | | | |
| Gel Particles | 969 | 135 | 95 | 47 |
| (5 cm × 5 cm) | | | | |
| pH c = 1% | 6.9 | 7.0 | 7.0 | 7.0 |
| Degree of substitution | 0.7 | 0.74 | 0.74 | 0.74 |
| [DS(CM)] | | | | |
| Sodium chloride (%) | <0.05 | <0.05 | <0.05 | <0.05 |
| Viscosity c = 1% | 1980 | 2080 | 2180 | 2540 |
| (mPas) | | | | |
| Turbidity c = 1% | 5.10 | 0.85 | 0.86 | 0.79 |
| (NTU) | | | | |
| Transmission c = 1% | 93.3 | 100.3 | 100.0 | 99.9 |

TABLE 2

| | Examples | | | |
|---|---|---|---|---|
| | Comparative | | | |
| Material and | example | Example | Example | Example |
| reaction conditions | (723) | 4 (724) | 5 (725) | 6 (726) |
| Pulp | Tartas Biofloc 96 | | | |
| mol pulp | 0.8 | | | |
| Ratio NaOH/Acid | 2 | 2.11 | 2.22 | 2.28 |
| Sodium Hydroxide | 1.8 | 1.9 | 2.0 | 2.1 |
| (mol/mol AGU) | | | | |
| Sodium Hydroxide (g) | 57.6 | 60.8 | 64 | 67.19 |
| Chloroacetic acid | 0.9 | 0.9 | 0.9 | 0.92 |
| (mol/mol AGU) | | | | |
| Chloroacetic acid | 85.48 | 85.48 | 85.48 | 87.38 |
| (79.6 wt-% in | | | | |
| water) (g) | | | | |
| Isopropanol (g) | 1793.3 | 1793.3 | 1793.3 | 1793.3 |
| Methanol (g) | 104.45 | 104.45 | 104.45 | 104.45 |
| Water (g) | 216.92 | 216.92 | 217.21 | 217.21 |
| Results | | | | |
| Gel Particles | 233 | 99 | 56 | 14 |
| (5 cm × 5 cm) | | | | |
| pH c = 1% | 6.9 | 6.9 | 6.9 | 6.8 |
| Degree of substitution | 0.7 | 0.74 | 0.75 | 0.74 |
| [DS(CM)] | | | | |
| Sodium chloride (%) | <0.05 | <0.05 | <0.05 | <0.05 |
| Viscosity c = 1% | 253 | 252 | 220 | 242 |
| (mPas) | | | | |
| Turbidity c = 1% | 2.45 | 2.31 | 0.99 | 0.74 |
| (NTU) | | | | |
| Transmission c = 1% | 98.8 | 99.7 | 100.2 | 101.4 |

TABLE 3

| | Examples | | | |
|---|---|---|---|---|
| | | | | Example |
| Material and | Example | Example | Example | 10 |
| reaction conditions | 7 (732) | 8 (737) | 9 (30-041) | (30-024) |
| Pulp | Gaomi | Tartas | Tartas | Tartas |
| | PCS 2400 | Biofloc 96 | Biofloc 96 | Biofloc 96 |
| mol pulp | 0.8 | 0.8 | 0.8 | 0.8 |
| Ratio NaOH/Acid | 2.42 | 2.5 | 2.87 | 5.11 |
| Sodium Hydroxide | 2.3 | 2.5 | 4.6 | 4.6 |
| (mol/mol AGU) | | | | |
| Sodium Hydroxide (g) | 73.59 | 79.99 | 147.19 | 147.19 |
| Chloroacetic acid | 0.95 | 1.0 | 1.6 | 0.9 |
| (mol/mol AGU) | | | | |
| Chloroacetic acid | 90.23 | 94.31 | 150.9 | 85.48 |
| (79.6 wt-% in | | | | |
| water) (g) | | | | |
| Isopropanol (g) | 1780.55 | 1780.55 | 1806.08 | 1806.08 |
| Methanol (g) | 104.31 | 104.31 | 104.59 | 104.59 |
| Water (g) | 225.08 | 224.91 | 198.36 | 200.36 |
| Hydrogen peroxide | 6 | 5 | 5 | 5 |
| (3% in water), (g) | | | | |
| Results | | | | |
| Gel Particles | 5 | 4 | 5 | 26 |
| (5 cm × 5 cm) | | | | |
| pH c = 1% | 7.1 | 6.9 | 7.1 | 6.8 |
| Degree of substitution | 0.71 | 0.72 | 0.78 | 0.47 |
| [DS(CM)] | | | | |
| Sodium chloride (%) | <0.05 | <0.05 | <0.05 | <0.05 |
| Viscosity c = 1% | 2484 | 166 | 130 | 255 |
| (mPas) | | | | |
| Turbidity c = 1% | 2.11 | 0.62 | 0.78 | 0.96 |
| (NTU) | | | | |
| Transmission c = 1% | 99.4 | 100.2 | 99.3 | 99.8 |
| (%) | | | | |

| | Examples |
|---|---|
| Material and | Example 11 |
| reaction conditions | (30-026) |
| Pulp | Tartas Biofloc 96 |
| mol pulp | 0.8 |
| Ratio NaOH/Acid | 3.45 |
| Sodium Hydroxide (mol/mol AGU) | 4.6 |
| Sodium Hydroxide (g) | 147.19 |
| Chloroacetic acid (mol/mol AGU) | 66.48 |
| Chloroacetic acid (79.6 wt-% in water) (g) | 90.23 |
| Isopropanol (g) | 1806.08 |
| Methanol (g) | 104.59 |
| Water (g) | 200.53 |
| Hydrogen peroxide (3% in water), (g) | 5 |
| Results | |
| Gel Particles (5 cm × 5 cm) | 32 |
| pH c = 1% | 7.0 |
| Degree of substitution [DS(CM)] | 0.39 |
| Sodium chloride (%) | <0.05 |
| Viscosity c = 1% (mPas) | 480 |
| Turbidity c = 1% (NTU) | 2.52 |
| Transmission c = 1% (%) | 99.4 |

1. A process of preparing carboxymethyl cellulose (CMC), said process comprising the steps of:
(a) suspending non-regenerated cellulose in a mixture of water/alcohol solvent, adding an alkalizing agent, and reacting the non-regenerated cellulose with the alkalizing agent in the presence of the water/alcohol solvent, optionally adding hydrogen peroxide,
(b) then adding a monohaloacetic acid or a salt thereof to the alkalized cellulose of step a), and reacting the alkalized cellulose of step a) with the monohaloacetic acid or the salt thereof,
(c) adding an acid to the reaction mixture of step b) to adjust the pH of the reaction mixture to 6.0 to 8.0, and
(d) removing the solvent after step c) is complete, wherein the ratio of alkalizing agent/monohaloacetic acid is above 2 and wherein the process after step d) is complete does not contain a further step of adding a base to adjust the pH of the reaction mixture and a further step of heat treating the reaction mixture.

2. The process according to claim 1, wherein the ratio of alkalizing agent/monohaloacetic acid is between 2.6-20, between 2.6-15, between 2.6-10, between 2.8-20, between 2.8-15, between 2.8-10, between 3.0-20, between 3.0-15, between 3.0-10, between 3.5-20, between 3.5-15 or between 3.5-10.

3. The process according to claim 1, wherein the ratio of alkalizing agent/monohaloacetic acid is between 4.0-20, between 4.0-15 or between 4.0-10.

4. The process according to claim 1, wherein the alcohol in step a) is isopropyl alcohol and or methanol.

5. The process according to claim 1, wherein from 10 to 100 mol of alcohol are used in step a) based on 1 mol of anhydroglucose unit of the cellulose.

6. The process according to claim 1, wherein the alkalizing agent in step a) is sodium hydroxide (NaOH), potassium hydroxide (KOH) or a mixture thereof, preferably sodium hydroxide (NaOH).

7. The process according to claim 1, wherein the alkalizing agent in step a) is added as a solid.

8. A carboxymethyl cellulose obtainable by the process of claim 1.

9. A carboxymethyl cellulose (CMC) having a degree of substitution (DS) equal to or below 0.5 and having a number of gel particles below 200/5 cm×5 cm, more preferably equal to or below 100/5 cm×5 cm, more preferably equal to or below 50/5 cm×5 cm, more preferable equal to or below 25/5 cm×5 cm, most preferably equal to or below 15/5 cm×5 cm, when measured as a 1% solution in water.

10. The carboxymethyl cellulose (CMC) according to claim 9, wherein the degree of substitution (DS) is below 0.4

11. A composition comprising carboxymethyl cellulose obtained or obtainable by the process of claim 1, wherein the number of gel particles is equal to or below 200/5 cm×5 cm equal to or below 100/5 cm×5 cm, more preferably equal to or below 50/5 cm×5 cm, more preferably equal to or below 25/5 cm×5 cm, more preferably equal to or below 15/5 cm×5 cm.

12. (canceled)

13. (canceled)

14. (canceled)

15. (canceled)

16. (canceled)

17. A battery electrode, wherein the electrode is coated with a composition obtained by a process of preparing carboxymethyl cellulose (CMC), said process comprising the steps of:
(a) suspending non-regenerated cellulose in a mixture of water/alcohol solvent, adding an alkalizing agent, and reacting the non-regenerated cellulose with the alkalizing agent in the presence of the water/alcohol solvent, optionally adding hydrogen peroxide,
(b) then adding a monohaloacetic acid or a salt thereof to the alkalized cellulose of step a), and reacting the alkalized cellulose of step a) with the monohaloacetic acid or the salt thereof,
(c) adding an acid to the reaction mixture of step b) to adjust the pH of the reaction mixture to 6.0 to 8.0, and
(d) removing the solvent after step c) is complete, wherein the ratio alkalizing agent/monohaloacetic acid is above 2 and wherein the process after step d) is complete does not contain a further step of adding a base to adjust the pH of the reaction mixture and a further step of heat treating the reaction mixture, wherein the number of gel particles is equal to or below 200/5 cm×5 cm equal to or below 100/5 cm×5 cm, more preferably equal to or below 50/5 cm×5 cm, more preferably equal to or below 25/5 cm×5 cm, more preferably equal to or below 15/5 cm×5 cm.

18. (canceled)

19. (canceled)

20. (canceled)

21. (canceled)

22. (canceled)

23. (canceled)

24. (canceled)

25. A composition comprising a carboxymethyl cellulose as defined in claim 9, wherein the number of gel particles is equal to or below 200/5 cm×5 cm equal to or below 100/5 cm×5 cm, more preferably equal to or below 50/5 cm×5 cm, more preferably equal to or below 25/5 cm×5 cm, more preferably equal to or below 15/5 cm×5 cm.
